(19) United States
(12) Patent Application Publication
(10) Pub. No.: US 2006/0076414 A1
(43) Pub. Date: Apr. 13, 2006

(54) Optical system for color laser printer

(76) Inventors: Gi Lyong Na, Kyunggi-do (KR); Wook Hee Lee, Kyunggi-do (KR); Jun Won An, Kyunggi-do (KR)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(21) Appl. No.: 11/134,866

(22) Filed: May 19, 2005

(30) Foreign Application Priority Data
Oct. 13, 2004 (KR) 10-2004-0081665

(51) Int. Cl. G06K 7/10

(52) U.S. Cl. 235/454

(57) ABSTRACT

The present invention relates, in general, to an optical system for a color laser printer and, more particularly, to an optical system for a color laser printer, in which a small number of laser scanning units are shared and collectively used by color components in the color laser printer, so that the number of required laser scanning units is reduced, thus reducing production costs. The optical system of the present invention includes a laser scanning unit for generating light and scanning a plurality of light beams. A plurality of conversion means converts the plurality of light beams into light beams having respective constant linear velocities, the respective conversion means corresponding to the light beams. A plurality of light receiving units receives the light beams from the conversion means, respectively, the respective light receiving units corresponding to the light beams.

### BACKGROUND OF THE INVENTION

1. Field of the Invention

The present invention relates, in general, to an optical system for a color laser printer and, more particularly, to an optical system for a color laser printer, in which a small number of laser scanning units are shared and collectively used by color components in the color laser printer, so that the number of required laser scanning units is reduced, thus reducing production costs.

2. Description of the Related Art

Recently, color laser printers have been popularized, but they are considerably more expensive than monochrome printers or color ink-jet printers.

A Laser Scanning Unit (LSU), which is a part constituting the optical unit of a color laser printer, is separately used for each of color modules, so that a total of four LSUs is used to construct a single color printer.

FIG. 1 is a view showing a conventional scanning apparatus for a monochrome laser printer;

As shown in FIG. 1, the conventional laser scanning apparatus includes a Laser Diode (LD) 100 for emitting a light beam in response to a video signal, a collimator lens 101 for converting the light beam emitted from the LD 100 into collimated light, a cylindrical lens 102 for converting the collimated light output from the collimator lens 101 into linear light parallel to a scanning direction, a polygon mirror 103 for moving and scanning the parallel linear light from the cylindrical lens 102 at a constant linear velocity, a polygon mirror driving motor 104 for rotating the polygon mirror 103 at a constant velocity, an f·θ lens 105 having a certain refractive index relative to an optical axis to deflect light, reflected from the polygon mirror 103 and moving at a constant angular velocity, in a main scanning direction, correct aberration of the light and focus the light onto a scanning surface, a reflective mirror 106 for image formation for reflecting laser beams output from the f-0 lens 105 in a predetermined direction and forming an image using the reflected laser beams on the surface of a photoconductive drum 107, which is an image formation surface, in the form of spots, a horizontal synchronizing mirror 108 for reflecting the laser beams from the f·θ lens 105 in a horizontal direction, and an optical sensor 109 for receiving laser beams reflected from the horizontal synchronizing mirror 108 and synchronizing the laser beams.

In the conventional laser scanning apparatus, the light beam output from the LD 100 is converted into collimated light after having passed through the collimator lens 101, converged in the direction of the rotation shaft of the polygon mirror 103 by the cylindrical lens 102, and reflected by the polygon mirror 103 rotating at a constant angular velocity. Light beams, reflected by the polygon mirror 103, pass through the f·θ lens 105, and the light beams then form spots, each with a certain diameter, on the photoconductive drum 107.

A conventional color printer is implemented using the monochrome optical system of FIG. 1 with respect to each of black, red, green and blue components, that is, four optical systems.

FIG. 2 is a view showing the connection of LSUs to Organic Photoconductive (OPC) drums, which are scanning objects, in a conventional color printer. LSU1, LSU2, LSU3 and LSU4 are used with respect to OPC drums 1, 2, 3 and 4 corresponding to black, red, green and blue components, respectively.

In relation to this construction, U.S. Pat. No. 5,784,094 discloses a scheme of employing four LDs that emit output light beams having different wavelengths as light sources, separating the light beams according to wavelength, and scanning the scanning objects corresponding to respective color components with corresponding beams. However, the beam separating method disclosed in the patent is disadvantageous in that it requires an expensive beam separator and must share optical devices, such as lenses, with respect to scanning objects, thus incurring a high cost to perform color printing.

Therefore, a method of producing color laser printers at low cost without deteriorating the performance thereof is required.

### SUMMARY OF THE INVENTION

Accordingly, the present invention has been made keeping in mind the above problems occurring in the prior art, and an object of the present invention is to provide an optical system, in which a small number of optical systems of Laser Scanning Units (LSUs) are shared and collectively used by respective Organic Photoconductive (OPC) drums, thus enabling color laser printers to be produced at low cost.

In order to accomplish the above object, the present invention provides an optical system, comprising a laser scanning unit for generating light and scanning a plurality of light beams; a plurality of conversion means for converting the plurality of light beams, scanned by the laser scanning unit, into light beams having respective constant linear velocities, the respective conversion means corresponding to the light beams; and a plurality of light receiving units for receiving the light beams from the conversion means, respectively, the respective light receiving units corresponding to the light beams.

Further, the present invention provides an optical system, comprising a laser scanning unit for a black component for generating and scanning light; a light receiving unit for a black component for receiving the light from the laser scanning unit for a black component; a laser scanning unit for color components for generating light and scanning a plurality of light beams; a plurality of conversion means for converting the light beams scanned by the laser scanning unit for color components into light beams having respective constant linear velocities, the respective conversion means corresponding to the light beams; and a plurality of light receiving units for receiving the light beams from the plurality of conversion means, the respective light receiving units corresponding to the light beams.

### BRIEF DESCRIPTION OF THE DRAWINGS

FIG. 1 is a view schematically showing a conventional optical system for a monochrome laser printer;

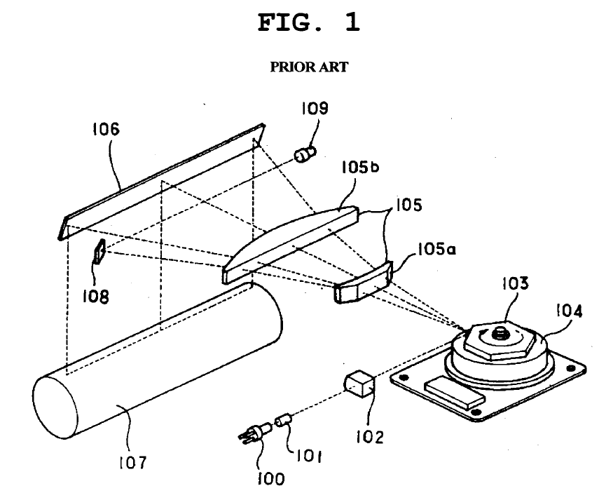

FIG. 2 is a view showing the connection of laser scanning units to organic photoconductive drums, which are scanning objects, in a conventional color printer;

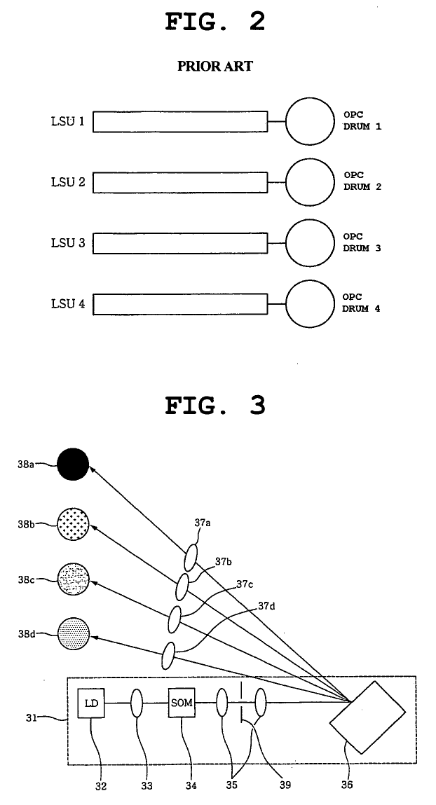

FIG. 3 is a view schematically showing the construction of an optical system according to an embodiment of the present invention;

FIGS. 4a and 4b are a plan view and a perspective view, respectively, of a polygon mirror according to the present invention;

FIGS. 5a to 5d are views showing the reflecting operation of a polygon mirror with four side surfaces A, B, C and D having different reflection angles; and

FIG. 6 is a view showing the construction of an optical system according to another embodiment of the present invention.

### DESCRIPTION OF THE PREFERRED EMBODIMENTS

Hereinafter, embodiments of the present invention will be described in detail with reference to the attached drawings.

Reference now should be made to the drawings, in which the same reference numerals are used throughout the different drawings to designate the same or similar components.

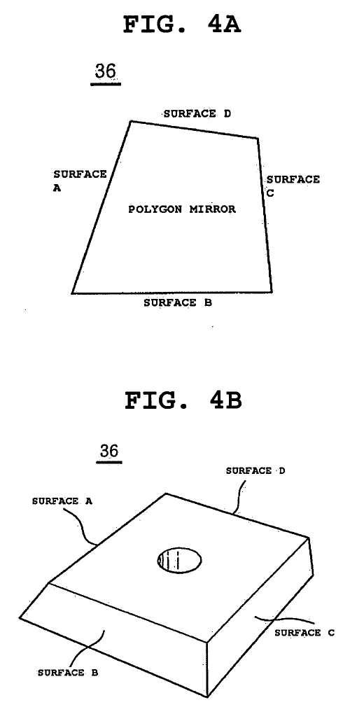

FIG. 3 is a view schematically showing the construction of an optical system according to an embodiment of the present invention.

As shown in FIG. 3, the optical system according to an embodiment of the present invention includes a laser scanning unit 31 for generating a single light beam and scanning a plurality of light beams, a plurality of F-θ lenses 37a to 37d which are conversion means that convert the plurality of light beams, scanned by the laser scanning unit 31, into light beams having respective constant linear velocities and correspond to respective light beams, and a plurality of Organic Photoconductive (OPC) drums 38a to 38d which receive the light beams from the F-θ lenses 37a to 37d, respectively, and correspond to the respective light beams.

In the embodiment of the present invention, the laser scanning unit 31 includes a laser diode 32 for generating light, converting the light into collimated light, and outputting the collimated light, a light modulator 34 for diffracting and modulating the collimated light and emitting a plurality of diffracted light beams, a slit 39 for passing therethrough only specific diffracted beams among the diffracted light beams emitted from the light modulator 34, and a polygon mirror 36 which is a single refraction means for refracting the specific diffracted light beams, having passed through the slit 39, and scanning the light beams corresponding to a plurality of color components.

As described above, only a single laser scanning unit 31 is used, so that light beams scan the four OPC drums.

The light generated by the laser diode 31 is converted into collimated light after having passed through an illumination lens 33, and the collimated light is incident on the light modulator 34. 0th-order and ±1st-order light beams, diffracted by the light modulator 34, pass through a projection lens 35, and only 0th-order or ±1st-order diffracted light beams are selected by the slit 39. The selected light beams are refracted by the polygon mirror 36 rotating at a predetermined velocity, and directed to respective OPC drums 38a to 38d. The OPC drums 38a to 38d are electrically charged by received light beams, are covered with ink fed from a toner cartridge (not shown), and transfer it to paper.

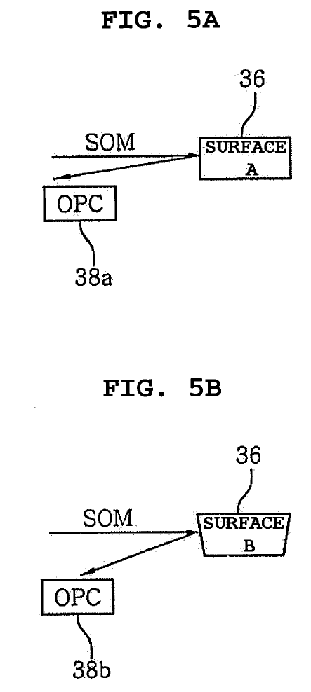

FIGS. 4a and 4b are a plan view and a perspective view, respectively, of the polygon mirror 36. As shown in FIGS. 4a and 4b, a polygon mirror that has four side surfaces, corresponding to the OPC drums 38a to 38d, respectively, and has a tetragonal cross section is preferably used as the polygon mirror 36. In this case, the four side surfaces A, B, C and D correspond to the four OPC drums 38a, 38b, 38c and 38d.

Preferably, in order to reflect light toward the four OPC drums 38a to 38d placed at different locations, the four side surfaces of the polygon mirror 36 form different reflection angles with respect to the respective OPC drums, as shown in FIGS. 4a and 4b. The polygon mirror 36 need only have side surfaces, the number of which corresponds to a multiple of 4, for example, 4, 8, 12 or 16, so as to scan the four OPC drums. In order to scan the four OPC drums placed at different locations, the side surfaces of the polygon mirror must have four different reflection angles, every fourth side surface having the same angle.

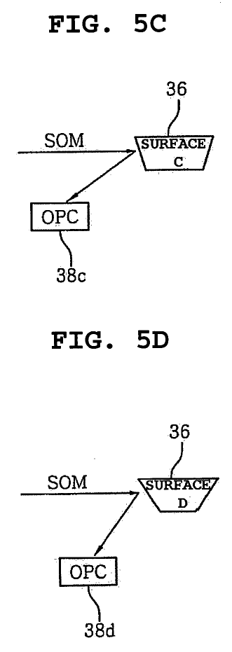

FIGS. 5a to 5d are views showing the reflecting operation of a polygon mirror with four side surfaces A, B, C and D having different reflection angles.

Preferably, the four OPC drums 38a to 38d receive signals corresponding to black, red, green and blue components, respectively, and are exposed to light to perform printing on paper.

In another embodiment of the present invention, a laser scanning unit includes a single laser diode for generating light, converting the light into collimated light and emitting the collimated light, and a single polygon mirror for refracting the collimated light, emitted from the laser diode, and scanning a plurality of light beams corresponding to a plurality of color components. This embodiment corresponds to the case in which a light modulation device is not used.

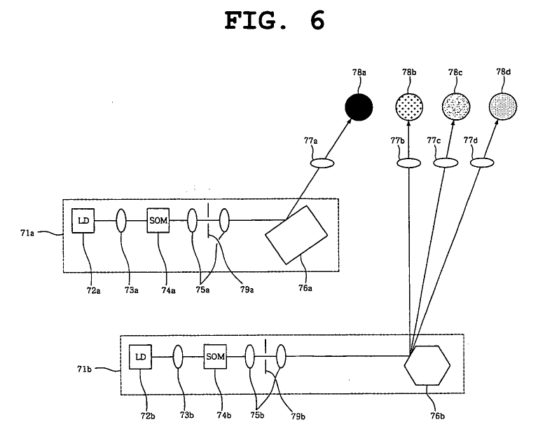

FIG. 6 is a view showing the construction of an optical system according to a further embodiment of the present invention.

A separate laser scanning unit 71a scans only an Organic Photoconductive (OPC) drum 78a for black component that is most frequently used, and a single laser scanning unit 71b scans OPC drums 78b to 78d for the remaining color components.

The laser scanning unit 71a or 71b includes a laser diode 72a or 72b for emitting light, converting the light into collimated light and emitting the collimated light, a light modulator 74a or 74b for diffracting and modulating the collimated light, emitted from the laser diode 72a or 72b, and emitting a plurality of diffracted light beams, a slit 79a or 79b for passing therethrough only specific diffracted light beams among the diffracted light beams emitted from the light modulator 74a or 74b, and a polygon mirror 76a or 76b which is a single refraction means for refracting the specific diffracted light beams, having passed through the slit 79a or 79b, and scanning a plurality of light beams corresponding to a plurality of color components.

In yet another embodiment of the present invention, a laser scanning unit includes a laser diode for generating light, converting the light into collimated light and emitting the collimated light, and a single polygon mirror for refracting the collimated light, emitted from the laser diode, and scanning a plurality of light beams corresponding to a plurality of color components. This embodiment corresponds to the case in which a light modulation device is not used.

For a polygon mirror 76a for a black component, a polygon mirror that has a predetermined cross section and side surfaces having a uniform reflection angle can be used. Since a polygon mirror 76b for Red, Green, Blue (RGB) components must scan three OPC drums 78b, 78c and 78d, a polygon mirror that has a cross section having sides, the number of which corresponds to a multiple of 3, such as a triangular or hexagonal cross section, can be used as the polygon mirror 76b. However, the side surfaces of the polygon mirror 76b must have three different reflection angles, every third side surface having the same angle, so as to scan the three OPC drums 78b, 78c and 78d.

In a monochrome mode that is most frequently used, only the OPC drum 78a is operated at high speed. In a color mode, the polygon mirror 76a is operated to cause its rotational speed to be ⅓ of that of the polygon mirror 76b.

As described above, the present invention provides an optical system for a color laser printer, in which a small number of optical systems of laser scanning units are shared and collectively used by respective OPC drums, so that color laser printers can be produced at low cost.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. An optical system, comprising:
a laser scanning unit for generating light and scanning a plurality of light beams;
a plurality of conversion means for converting the plurality of light beams, scanned by the laser scanning unit, into light beams having respective constant linear velocities, the respective conversion means corresponding to the light beams; and
a plurality of light receiving units for receiving the light beams from the conversion means, respectively, the respective light receiving units corresponding to the light beams.

2. The optical system according to claim 1, wherein the laser scanning unit comprises:
single light generation means for generating light, converting the light into collimated light and emitting the collimated light; and
single refraction means for refracting the collimated light, emitted from the light generation means, and scanning a plurality of light beams corresponding to a plurality of color components.

3. The optical system according to claim 1, wherein the laser scanning unit comprises:
single light generation means for generating light, converting the light into collimated light and emitting the collimated light;
light modulation means for diffracting and modulating the collimated light, emitted from the light generation means, and outputting a plurality of diffracted light beams; and
single refraction means for selectively refracting the diffracted light beams, output from the light modulation means, and scanning a plurality of light beams corresponding to a plurality of color components.

4. The optical system according to claim 2, wherein the refraction means is a rotating mirror that includes N (where N is a natural number) sets of four adjacent refractive surfaces having different inclination angles.

5. The optical system according to claim 3, wherein the refraction means is a rotating mirror that includes N (where N is a natural number) sets of four adjacent refractive surfaces having different inclination angles.

6. An optical system, comprising:
a laser scanning unit for a black component for generating and scanning light;
a light receiving unit for a black component for receiving the light from the laser scanning unit for a black component;
a laser scanning unit for color components for generating light and scanning a plurality of light beams;
a plurality of conversion means for converting the light beams scanned by the laser scanning unit for color components into light beams having respective constant linear velocities, the respective conversion means corresponding to the light beams; and
a plurality of light receiving units for receiving the light beams from the plurality of conversion means, the respective light receiving units corresponding to the light beams.

7. The optical system according to claim 6, wherein the laser scanning unit for a black component comprises:
light generation means for generating light, converting the light into collimated light and emitting the collimated light;
refraction means for refracting and scanning the collimated light emitted from the light generation means; and
conversion means for converting the light scanned by the refraction means into light having a constant linear velocity.

8. The optical system according to claim 6, wherein the laser scanning unit for a black component comprises:
light generation means for generating light, converting the light into collimated light and emitting the collimated light;
light modulation means for diffracting and modulating the collimated light, emitted from the light generation means, and outputting a plurality of diffracted light beams;
refraction means for selectively refracting the diffracted light beams, output from the light modulation means, and scanning the plurality of light beams; and
conversion means for converting the light beams scanned by the refraction means into light beams having respective constant linear velocities.

9. The optical system according to claim 6, wherein the laser scanning unit for color components comprises:
light generation means for generating light, converting the light into collimated light and emitting the collimated light; and
single refraction means for refracting the collimated light, emitted from the light generation means, and scanning a plurality of light beams corresponding to a plurality of color components.

10. The optical system according to claim 6, wherein the laser scanning unit for color components comprises:
light generation means for generating light, converting the light into collimated light and emitting the collimated light;
light modulation means for diffracting and modulating the collimated light, emitted from the light generation means, and outputting a plurality of diffracted light beams; and
refraction means for selectively refracting the diffracted light beams, output from the light modulation means, and scanning a plurality of light beams corresponding to a plurality of color components.

11. The optical system according to claim 7, wherein the refraction means is a rotating mirror that includes N (where N is a natural number) sets of three adjacent refractive surfaces having different inclination angles.

12. The optical system according to claim 8, wherein the refraction means is a rotating mirror that includes N (where N is a natural number) sets of three adjacent refractive surfaces having different inclination angles.

13. The optical system according to claim 9, wherein the refraction means is a rotating mirror that includes N (where N is a natural number) sets of three adjacent refractive surfaces having different inclination angles.

14. The optical system according to claim 10, wherein the refraction means is a rotating mirror that includes N (where N is a natural number) sets of three adjacent refractive surfaces having different inclination angles.
